(19) United States
(12) Patent Application Publication
(10) Pub. No.: US 2026/0074204 A1
(43) Pub. Date: Mar. 12, 2026

(54) ELECTRODE ACTIVE MATERIAL AND BATTERY

(71) Applicant: TOYOTA JIDOSHA KABUSHIKI KAISHA, Toyota-shi (JP)

(72) Inventors: Jun YOSHIDA, Mishima-shi (JP); Hirofumi NAKAMOTO, Sunto-gun (JP); Ryosuke FURUYA, Gotemba-shi (JP); Chikuen WONG, Mishima-shi (JP); So YUBUCHI, Sunto-gun (JP); Kazushige NOMOTO, Sunto-gun (JP)

(73) Assignee: TOYOTA JIDOSHA KABUSHIKI KAISHA, Toyota-shi (JP)

(21) Appl. No.: 19/256,383

(22) Filed: Jul. 1, 2025

(30) Foreign Application Priority Data
Sep. 6, 2024 (JP) 2024-153876

(51) Int. Cl. H01M 4/38; H01M 4/02; H01M 4/62

(52) U.S. Cl. CPC H01M 4/386; H01M 2004/021; H01M 4/621

(57) ABSTRACT

The present disclosure relates to an electrode active material and a battery. An electrode active material using a granulated body. The granulated body is a secondary particle provided by primary particles containing a Si element with use of a binder. In the electrode active material, a content of an organic solvent is 950 ppm or less.

### CROSS-REFERENCE TO RELATED APPLICATION

This application claims priority to Japanese Patent Application No. 2024-153876 filed on Sep. 6, 2024. The disclosure of the above-identified application, including the specification, drawings, and claims, is incorporated by reference herein in its entirety.

### BACKGROUND

### 1. Technical Field

The present disclosure relates to an electrode active material and a battery.

### 2. Description of Related Art

In Japanese Unexamined Patent Application Publication No. 2024-017797 (JP 2024-017797 A), a battery using granulated bodies obtained by causing silicon primary particles to become secondary particles by a binder as a negative-electrode active material is disclosed.

### SUMMARY

There has been a problem in that cycle characteristics deteriorate in a battery including a Si-based active material.

Thus, an object of the present disclosure is to provide an electrode active material capable of reducing the deterioration of cycle characteristics in a battery including a Si-based active material. In addition, a battery using the same is provided.

The present inventors have gained an insight that one reason of deterioration of cycle characteristics in a battery including a Si-based active material is that there is a residual of an organic solvent used at the time of synthesis of granulated bodies. The above is conceived to occur due to the following reason. Specifically, the solvent contained in a polymer solution at the time of synthesis remains in the particles, thereby causing peripheral materials to deteriorate during the operation of the battery. As a result, the battery performance deteriorates. The inventors have completed the disclosure based on such insight.

The present application discloses an electrode active material using a granulated body. The granulated body is a secondary particle provided by primary particles containing a Si element with use of a binder. In the electrode active material, a content of an organic solvent is 950 ppm or less.

A content of the organic solvent may be 1.2 ppm or more and 250 ppm or less.

The organic solvent may be at least one of alcohols, glycols, esters, or

amides.

The present application discloses a battery including a mixture layer having the electrode active material described above.

The present application discloses an all-solid-state battery including an all-solid-electrolyte layer, and a mixture layer that is laminated on the all-solid-electrolyte layer and has the electrode active material.

With the present disclosure, it is possible to inhibit the deterioration of the cycle characteristics in the battery including the Si-based active material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view describing a layer configuration of an electrode body 11 of a solid-state battery.

### DETAILED DESCRIPTION OF EMBODIMENTS

### 1. Configuration of Battery

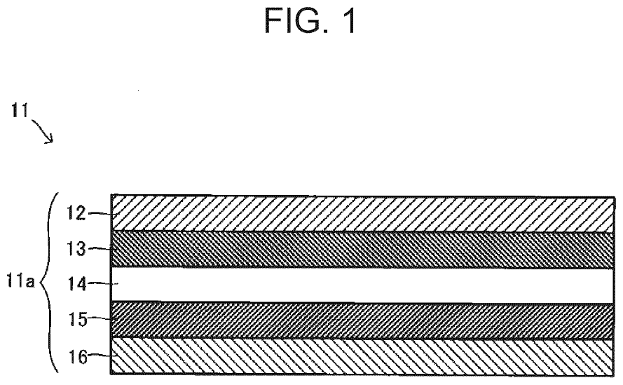

In FIG. 1, a view describing a solid-state battery (all-solid-state battery) according to one form is described. Description is made here with use of an all-solid-state battery as one typical example, but the present disclosure does not necessarily need to be an all-solid-state battery, and can be applied to any battery having an electrode body and an exterior body that seals the electrode body (for example, a solid-state battery (semi-solid-state battery) including a solid electrolyte and an electrolytic solution and all batteries including only an electrolytic solution). In FIG. 1, out of the solid-state battery, a layer configuration of an electrode body 11 included here is shown. The solid-state battery is obtained by sealing the electrode body 11 as above in the exterior body. For example, the electrode body 11 having a substantially rectangular shape in plan view is contained in the exterior body having a substantially rectangular shape in plan view. At this time, a positive-electrode terminal extends from a positive-electrode current collector of the electrode body 11 and a negative-electrode terminal extends from a negative-electrode current collector of the electrode body 11 and distal ends thereof are disposed to protrude from the exterior body. Each configuration of the laminated body 11 and relationships thereof are described in more detail below.

The electrode body 11 has a positive-electrode current collector 12, a positive-electrode mixture layer 13, an electrolyte layer 14, a negative-electrode mixture layer 15, and a negative-electrode current collector 16. In the present form, the positive-electrode current collector 12, the positive-electrode mixture layer 13, the electrolyte layer 14, the negative-electrode mixture layer 15, and the negative-electrode current collector 16 are laminated in the stated order, to thereby form a unit element 11a. A plurality of the unit elements 11a is laminated, to thereby form the electrode body 11 (only one unit element 11a is shown in FIG. 1). As described above, the positive-electrode terminal is electrically connected to the positive-electrode current collector 12 of the electrode body 11, and the negative-electrode terminal is electrically connected to the negative-electrode current collector 16 of the electrode body 11.

### 1.1. Positive-Electrode Current Collector

The positive-electrode current collector 12 is laminated on the positive-electrode mixture layer 13 and collects current from the positive-electrode mixture layer 13. In the present form, the positive-electrode current collector 12 has a quadrilateral foil form in plan view and can be made of a positive-electrode current collector foil that is a metallic foil, and an electrically-conductive resin layer and a carbon layer laminated on the positive-electrode current collector foil. The carbon layer is laminated on the positive-electrode mixture layer 13. As a result, the positive-electrode current collector 12 is laminated on the positive-electrode mixture layer 13. As the material that forms the positive-electrode current collector, examples of the material of the metallic foil include stainless steel, nickel, chromium, gold, platinum, aluminum, iron, titanium, and zinc. A metallic foil obtained by performing plating or vapor deposition of nickel, chromium, carbon, and the like on the metallic foil above may be used. The conductive resin layer can be made of resin in which an electrically-conductive material is dispersed, and the carbon layer can be made of a material containing carbon.

### 1.2. Positive Electrode Mixture Layer

Regarding the positive-electrode mixture layer 13, the positive-electrode current collector 12 is laminated on one front surface, and the electrolyte layer 14 is laminated on the other front surface. In the present form, the positive-electrode mixture layer 13 has a quadrilateral sheet form in plan view. The positive-electrode mixture layer 13 is a layer that contains at least a positive-electrode active material. The positive-electrode mixture layer may contain at least one of an electrolyte, an electrically-conductive auxiliary agent, and a binder as needed. The thickness of the positive-electrode mixture layer 13 is not particularly limited but can be 1 μm or more and 100 μm or less and is more preferably 30 μm or more and 100 μm or less.

### Positive-Electrode Active Material

Examples of the positive-electrode active material include an oxide active material. Examples of the oxide active material include a ternary system (Li(NiₓCo_{y}Mn_{z})O₂), an NCA system (Li(NiₓCo_{y}Al_{z})O₂), rock-salt-layer active materials such as LiCoO₂, LiMnO₂, LiNiO₂, LiVO₂, and Li₁₊ₓNi_{1/3}Co_{1/3}Mn_{1/3}O₂, spinel-type active materials such as LiMn₂O₄, Li₄Ti₅O₁₂, and Li(Ni_{0.5}Mn_{1.5})O₄, olivine-type active materials such as LiFePO₄, LiMnPO₄, LiNiPO₄, and LiCoPO₄, a dissimilar element substitution Li—Mn spinel active material expressed by Li₁₊ₓMn_{2-x-y}M_{y}O₄ (M is one or more types selected from Al, Mg, Co, Fe, Ni, and Zn), and LiₓTiO_{y}.

In a front surface of the active material, a coat layer that contains a Li ion conductive oxide may be formed. This is because the reaction between the active material and the solid electrolyte (in particular, the sulfide solid electrolyte) can be reduced. Examples of the Li ion conductive oxide include LiNbO₃, Li₄Ti₅O₁₂, and Li₃PO₄. The thickness of the coat layer is 1 nm or more and 30 nm or less, for example.

Examples of the shape of the positive-electrode active material include a particulate form. An average particle size (D50) of the positive-electrode active material is not particularly limited, but is 10 nm or more, for example, and may be 100 nm or more. Meanwhile, the average particle size (D50) of the positive-electrode active material is 50 μm or less, for example, and may be 20 μm or less. The average particle size (D50) can be calculated from measurement by a laser diffraction particle size analyzer or a scanning electron microscope (SEM), for example.

### Electrolyte

The electrolyte includes at least a solid electrolyte in an all-solid-state battery or a semi-solid-state battery and includes a liquid electrolyte (electrolytic solution) in the semi-solid-state battery or a battery with only an electrolytic solution.

Examples of the solid electrolyte include an inorganic solid electrolyte such as a sulfide solid electrolyte, an oxide solid electrolyte, a nitride solid electrolyte, and a halide solid electrolyte, and an organic polyelectrolyte such as a polymer electrolyte. Examples of the sulfide solid electrolyte include a solid electrolyte containing a Li element, an X element (X is at least one type of P, As, Sb, Si, Ge, Sn, B, Al, Ga, and In), and a S element. The sulfide solid electrolyte may further contain at least one of an O element and a halogen element. Examples of the halogen element include a F element, a Cl element, a Br element, and an I element. The sulfide solid electrolyte may be glass (amorphous) or may be glass ceramics. Examples of the sulfide solid electrolyte include Li₂S—P₂S₅, LiI—Li₂S—P₂S₅, LiI—LiBr—Li₂S—P₂S₅, Li₂S—SiS₂, LiI—Li₂S—SiS₂, Li₂S—P₂O₅, LiI—Li₃PO₄—P₂S₅, Li₂S—GeS₂, and Li₂S—P₂S₅—GeS₂.

The electrolytic solution preferably contains supporting salt and a solvent. Examples of the supporting salt (lithium salt) of the electrolytic solution having lithium-ion conductivity include inorganic lithium salt such as LiPF₆, LiBF₄, LiClO₄, and LiAsF₆ and organic lithium salt such as LiCF₃SO₃, LiN(CF₃SO₂)₂, LiN(C₂F₅SO₂)₂, LiN(FSO₂)₂, and LiC(CF₃SO₂)₃. Examples of the solvent used in the electrolytic solution include cyclic ester (cyclic carbonate) such as ethylene carbonate (EC), propylene carbonate (PC), and butylene carbonate (BC) and chained ester (chained carbonate) such as dimethyl carbonate (DMC), diethyl carbonate (DEC), and ethyl methyl carbonate (EMC). The electrolytic solution preferably contains two or more types of solvents.

The mass ratio between the positive-electrode active material and the electrolyte is preferably from 85/15 to 30/70 and more preferably from 80/20 to 50/50 for the positive-electrode active material/the electrolyte.

### Electrically-Conductive Auxiliary Agent and Binder

Examples of the electrically conductive material include a carbon material, metallic particles, and an electrically conductive polymer. Examples of the carbon material include particulate carbon materials such as acetylene black (AB) and Ketjen Black (KB) and fibrous carbon materials such as the carbon fiber, a carbon nanotube (CNT), and carbon nanofiber (CNF). Examples of the binder include a rubber-based binder and a fluorine-based binder.

### 1.3. Electrolyte Layer

The electrolyte layer 14 is a layer formed between the positive-electrode mixture layer and the negative-electrode mixture layer and contains at least an electrolyte. The electrolyte may be only a solid electrolyte or may contain a liquid electrolyte (electrolytic solution). The specific solid electrolyte and electrolytic solution are similar to the electrolyte described for the positive-electrode mixture layer described above. The thickness of the electrolyte layer is 0.1 μm or more and 1000 μm or less, for example. The thickness of the electrolyte layer is more preferably 0.1 μm or more and 300 μm or less and further preferably 1 μm or more and 100 μm or less.

### 1.4. Negative-Electrode Mixture Layer

The negative-electrode mixture layer 15 is a layer containing at least a negative-electrode active material and may contain at least one of an electrolyte, an electrically-conductive auxiliary agent, and a binder. The electrolyte, the electrically-conductive auxiliary agent, and the binder are similar to those in the positive-electrode mixture layer described above. The thickness of the negative-electrode mixture layer 15 is not particularly limited but can be 1 μm or more and 100 μm or less and is more preferably 30 μm or more and 100 μm or less.

### Negative-Electrode Active Material

The negative-electrode active material (electrode active material) in the present form is granulated bodies obtained by causing primary particles containing Si elements to become secondary particles by a binder. The primary particle is not particularly limited as long as the primary particle contains a Si element, but description is made here with use of a porous silicon particle as one example. In other words, in the present form, as the negative-electrode active material, granulated bodies obtained by coupling a plurality of porous silicon particles to each other by the binder are used.

### Porous Silicon Particle

The porous silicon particle contains silicon having a plurality of voids. The form of the voids in the porous silicon particle is not particularly limited. The porous silicon particle may be a particle containing nanoporous silicon. Nanoporous silicon is silicon having a plurality of pores each having a pore diameter in nanometer order (less than 1000 nm, preferably 100 nm or less). The porous silicon particle may include pores each having a diameter of 55 nm or less. The pore having a diameter of 55 nm or less is not easily crushed even by pressing. In other words, the porous property of the porous silicon particle having pores each having a diameter of 55 nm or less is easily maintained even after pressing. For example, for 1 g of the porous silicon particles, pores each having a diameter of 55 nm or less may be included by 0.21 cc/g or more, 0.22 cc/g or more, or 0.23 cc/g or more and may be included by 0.30 cc/g or less, 0.28 cc/g or less, or 0.26 cc/g or less. The amount of pores having a diameter of 55 nm or less included in the porous silicon particle can be obtained by a nitrogen gas adsorption method or pore size distribution in accordance with a DFT method, for example.

The porous silicon particle may have a predetermined void rate. The void rate of the porous silicon particle may be 1% or more, 5% or more, 10% or more, or 20% or more and may be 80% or less, 70% or less, 60% or less, 50% or less, 40% or less, or 30% or less, for example. The void rate may be obtained by observation by a scanning electron microscope (SEM) and the like, for example. The number of samples is preferably large and is 100 or more, for example. The void rate can be an average value obtained from those samples.

However, the voids in the porous silicon particles, the voids in the granulated bodies, the voids outside the granulated bodies, and the like do not necessarily need to be distinguished from each other. The void rate of the entire negative-electrode mixture layer including the voids in the porous silicon particles, the voids in the granulated bodies, the voids outside of the granulated bodies, and the like only needs to exceed 15%. In other words, an effect of inhibiting the thickness change of a negative electrode at the time of charging can be expected as long as the void rate of the entire negative-electrode mixture layer exceeds 15% regardless of the magnitude of the void rate of the porous silicon particles, the magnitude of the void rate of the granulated bodies, and the magnitude of the void rate outside the granulated bodies.

The composition of the porous silicon particle is not particularly limited. The rate of the Si element in all of the elements contained in the porous silicon particle may be 50 mol % or more, 70 mol % or more, or 90 mol % or more, for example. The porous silicon particle may contain elements other than the Si element such as a Li element. Examples of the other elements include a Sn element, a Fe element, a Co element, a Ni element, a Ti element, a Cr element, a B element, and a P element besides the Li element. The porous silicon particle may contain impurities such as oxide. The porous silicon particle may be amorphous or may be a crystal. The crystal phase included in the porous silicon particle is not particularly limited.

The shape and size of the porous silicon particle is not particularly limited. The average primary particle diameter of the porous silicon particle may be 30 nm or more, 50 nm or more, 100 nm or more, or 150 nm or more, and may be 10 μm or less, 5 μm or less, 3 μm or less, 2 μm or less, or 1 μm or less, for example. The particle diameter can be obtained by observation by an electron microscope such as a SEM and is obtained as an average value of the maximum Feret diameters of a plurality of particles, for example. The number of samples is preferably large, and is 20 or more, for example, and may be 50 or more or 100 or more.

### Binder

The binder couples the porous silicon particles to each other. The type of the binder is not particularly limited. The binder may be selected from a butadiene rubber (BR) based binder, a butyl rubber (IIR) based binder, an acrylate-butadiene rubber (ABR) based binder, a styrene-butadiene rubber (SBR) based binder, a polyvinylidene fluoride (PVdF) based binder, a polytetrafluoroethylene (PTFE) based binder, a polyimide (PI) based binder, a carboxymethyl-cellulose (CMC) based binder, a polyacrylate-based binder, and a polyacrylic-acid-ester-based binder, for example. It is possible to use only one type of binder or use two or more types of binders in combination.

### Rate of Porous Silicon Particles and Binder Included in Granulated Body

The rate of the porous silicon particles and the binder included in the granulated body is not particularly limited as long as the rate is a degree with which the granulated body can be formed. For example, the rate of the binder included in the total amount of the porous silicon particles and the binder may be 1 mass % or more, 5 mass % or more, or 8 mass % or more and 30 mass % or less, 28 mass % or less, 26 mass % or less, 24 mass % or less, or 22 mass % or less. When the rate of the binder included in the total of the porous silicon particles and the binder is 1 mass % or more and 30 mass % or less, a greater charge/discharge capacity is easily secured.

### Number of Porous Silicon Particles Included in Granulated Body

The porous silicon particles are included in one granulated body by a plurality of numbers. The number of porous silicon particles included in one granulated body may be three or more, five or more, 10 or more, or 50 or more and may be 1000 or less, for example. The number of porous silicon particles included in the granulated body can be determined by elemental analysis or an image obtained by observation by an electron microscope and the like, for example.

### Particle Diameter of Granulated Body

The granulated body is a secondary particle in which a plurality of porous silicon particles is agglutinated via a binder. An average particle diameter of the granulated bodies is not particularly limited. The average particle diameter of the granulated bodies may be 100 nm or more, 1 μm or more, 2 μm or more, or 3 μm or more and may be 20 μm or less, 15 μm or less, or 10 μm or less. The average particle diameter of the granulated bodies included in the negative-electrode mixture layer can be obtained by observation by an electron microscope such as a SEM and is obtained as an average value of the maximum Feret diameters of the granulated bodies, for example. The number of samples are preferably large, and is 20 or more, for example, and may be 50 or more or 100 or more. Alternatively, an average particle diameter (D50, a median diameter) of the granulated bodies measured with use of a laser diffraction particle size distribution measuring apparatus after only the granulated bodies are taken out from the negative-electrode mixture layer may be 100 nm or more, 1 μm or more, 2 μm or more, or 3 μm or more and may be 20 μm or less, 15 μm or less, or 10 μm or less.

### Shape of Granulated Body

The negative-electrode mixture layer may be formed by pressing a mixture. At this time, the granulated body may be crushed in the pressing direction and may have an aspect ratio that is equal to or more than a predetermined aspect ratio. As a result of the granulated body being pressed to a degree of having an aspect ratio that is equal to or more than a predetermined aspect ratio, the contact resistance in the granulated body, the contact resistance between the granulated bodies, the contact resistance between the granulated body and another material, and the like are reduced, and the resistance of the entire negative electrode easily becomes even smaller.

### Solvent

An organic solvent is included when the granulated body is synthesized (the method of synthesization is exemplified in the example), but the organic solvent may remain in the granulated body. It is preferred that the organic solvent be at least one of alcohols, glycols, esters, and amides and have a relatively high polarity. More specifically, examples include butyl acetate, propylene glycol (PG), 2-butanol, and dimethylformamide (DMF). The above does not necessarily need to be singly included and a plurality of the above may be included.

The residual solvent amount (the content of the organic solvent) in the granulated body is 950 ppm or less in mass ratio to the entire granulated body. The residual solvent amount is preferably 300 ppm or less, more preferably 250 ppm or less, and most preferably 100 ppm or less. As a result, the degradation of the cycle characteristics can be inhibited. Meanwhile, the residual solvent amount is preferably 1.2 ppm or more and more preferably 89 ppm or more. As a result, it is possible to inhibit the degradation of the cycle characteristics while reducing problems regarding the production efficiency necessary for a process for drying (removal of the solvent) and problems regarding cost such as the increase of cost.

### 1.5. Negative-Electrode Current Collector

The negative-electrode current collector 16 is laminated on the negative-electrode mixture layer 15 and collects current from the negative-electrode mixture layer 15. In the present form, the negative-electrode current collector 16 has a quadrilateral foil form in plan view and can be made of stainless steel, copper, nickel, carbon, and aluminum and alloys thereof, for example. Alternatively, the negative-electrode current collector 16 may be obtained by performing plating and vapor deposition of nickel, chromium, and carbon on the above.

### 1.6. Positive-Electrode Terminal and Negative-Electrode Terminal

The positive-electrode terminal and the negative-electrode terminal are members having electrical conductivity and are terminals for electrically connecting poles to the outside. The positive-electrode terminal has one end electrically connected to the positive-electrode current collector 12 and another end that passes through the exterior body and is exposed to the outside. The negative-electrode terminal has one end electrically connected to the negative-electrode current collector 16 and another end that passes through the exterior body and is exposed to the outside.

### 1.7. Exterior Body

The exterior body is formed by a rectangular sheet-form member in plan view and includes a first sheet and a second sheet, for example. The electrode body 11 is included in a place between the first sheet and the second sheet, and sealing is performed by joining an outer peripheral end portion of the first sheet and an outer peripheral end portion of the second sheet to each other. Therefore, the exterior body has a bag form, and the electrode body 11 is included and sealed on the inside thereof.

The first sheet and the second sheet can be made of laminating films. Here, the laminating film is a film having a metallic layer and a sealant layer. Examples of metal and the like used in the laminating film include aluminum and stainless steel, and examples of a material used in the sealant layer include polypropylene, polyethylene, polystyrene, and polyvinyl chloride that are thermoplastic resin.

### 2. Example

In an example, the deterioration of the cycle characteristics was examined by changing the residual solvent amount (the content of an organic solvent) in a negative-electrode mixture layer.

### 2.1. Production of Electrode Body (Battery)

### Production of Positive-Electrode Mixture Layer

Butyl butyrate serving as an organic solvent, SBR serving as a binder, carbon fiber obtained by a gas phase method serving as an electrically-conductive auxiliary agent, Li₂S—P₂S₅-based glass ceramics serving as a sulfide solid electrolyte, and LiNi_{0.8}Co_{0.15}Mn_{0.05}O₂ serving as a positive-electrode active material were placed in a container made of polypropylene and were kneaded with use of an ultrasonic homogenizer. As a result, a slurry for a positive-electrode mixture layer was obtained. The obtained slurry was applied onto an Al foil by a blade method with use of an applicator. The applied material was dried on a hot plate having a suitable temperature for 30 minutes.

### Production of Negative-Electrode Mixture Layer

Granulated bodies were first synthesized for the production of the negative-electrode mixture layer. A binder solution obtained by dissolving and dispersing PVdF serving as a binder in the organic solvent was produced, and Si particles were put into the binder solution, to thereby obtain a slurry. Granulated bodies before drying were obtained by performing composite formation of the slurry by a spray dry method. The types of the used organic solvents are shown in Table 1. The solvent was removed by performing vacuum drying of the obtained granulated bodies before drying at 100° C. The amount of the residual organic solvent in the granulated bodies was adjusted by changing the amount of time of the vacuum drying. The amount of the residual organic solvent (the content of the organic solvent) is shown in Table 1. A gas chromatograph-mass spectrometry (GC-MS) apparatus was used for the measurement of the amount of the residual organic solvent. More specifically, the measurement was performed where the apparatus was GCMS-QP™ 2020NX manufactured by SHIMADZU CORPORATION, and the measurement conditions were conditions in which the rate of temperature rise was 5° C./minute and the temperature of the temperature rise was 300° C. As a result, the granulated body was obtained.

The produced granulated body, SBR serving as the binder, carbon fiber obtained by the gas phase method serving as the electrically-conductive auxiliary agent, and Li₂S—P₂S₅-based glass ceramics serving as the sulfide solid electrolyte were added to butyl butyrate serving as the organic solvent. After the addition, kneading was performed with use of the ultrasonic homogenizer, and a slurry for the negative-electrode mixture layer was obtained. The obtained slurry was applied onto a Cu foil (manufactured by UACJ) by a blade method with use of an applicator and was dried.

### Production of Solid Electrolyte Layer

Butyl butyrate serving as the organic solvent, SBR serving as the binder, and Li₂S—P₂S₅-based glass ceramics serving as the sulfide solid electrolyte were added. After the addition, kneading was performed with use of the ultrasonic homogenizer, and a slurry for a solid electrolyte layer was obtained. The obtained slurry was applied onto an Al foil by the blade method with use of an applicator and was dried.

### Production of Electrode Body

Each of the produced layers was molded in a strip form, and the positive-electrode mixture layer and the solid electrolyte layer were combined and roll-pressed at the pressure of 50 kN/cm² and 165° C., and the Al foil was peeled off. As a result, a laminated body of the positive-electrode mixture layer and the solid electrolyte layer was obtained. The negative-electrode mixture layer and the solid electrolyte layer were combined and roll-pressed at the pressure of 50 kN/cm² and 25° C., and the Al foil was peeled off. As a result, a laminated body of the negative-electrode mixture layer and the solid electrolyte layer was obtained. The laminated body of the negative-electrode mixture layer and the solid electrolyte layer was punched out by the diameter of 13 mm, and the laminated body of the positive-electrode mixture layer and the solid electrolyte layer was punched out by the diameter of 11.28 mm. The solid electrolyte layer was further transferred to the punched out laminated body of the negative-electrode mixture layer and the solid electrolyte layer by uniaxial pressing, and the laminated body of the positive-electrode mixture layer and the solid electrolyte layer was combined therewith. Lastly, tabs were attached to the electrodes, and the electrodes were sealed in an aluminum laminate serving as an exterior body by a vacuum lamination sealer and were confined by a pressure of 5 MPa. As a result, a battery was obtained.

### 2.2. Test Method and Result

Charging and discharging of the produced battery were repeated at 1 C (C rate), and a rate obtained by expressing the change in the capacity at the 50th cycle as compared to the capacity of the first cycle by a percentage was expressed as a capacity retention rate (%). It can be said that the deterioration of the cycle characteristics was able to be inhibited more as the capacity retention rate became higher. The result is shown in Table 1.

TABLE 1

| | Organic | Residual | Capacity |
|---|---|---|---|
| | solvent | organic solvent | retention |
| | type | amount (ppm) | rate (%) |
| Comparative Example 1 | Butyl | 988 | 58.0 |
| Example 1 | acetate | 288 | 81.5 |
| Example 2 | | 195 | 96.8 |
| Example 3 | | 106 | 97.1 |
| Example 4 | | 1.8 | 97.3 |
| Comparative Example 2 | Propylene | 1020 | 61.0 |
| Example 5 | glycol | 297 | 82.3 |
| Example 6 | | 188 | 96.7 |
| Example 7 | | 96 | 97.0 |
| Example 8 | | 1.5 | 97.1 |
| Comparative Example 3 | Dimethyl- | 985 | 62.0 |
| Example 9 | formamide | 301 | 81.0 |
| Example 10 | | 202 | 97.3 |
| Example 11 | | 99 | 97.3 |
| Example 12 | | 1.2 | 97.4 |
| Comparative Example 4 | 2-butanol | 1011 | 58.0 |
| Example 13 | | 324 | 82.0 |
| Example 14 | | 199 | 96.5 |
| Example 15 | | 89 | 96.6 |
| Example 16 | | 2 | 97.0 |

As can be understood from those results, the cycle characteristics deteriorated when the amount of the residual organic solvent exceeded 950 ppm. Meanwhile, it can also be understood that, when the amount of the residual organic solvent was less than 1.2 ppm, the efficiency in improvement regarding the inhibition of the deterioration of the characteristics became low.

What is claimed is:

1. An electrode active material using a granulated body, the granulated body being a secondary particle provided by primary particles containing a Si element with use of a binder, wherein a content of an organic solvent is 950 ppm or less.

2. The electrode active material according to claim 1, wherein a content of the organic solvent is 1.2 ppm or more and 250 ppm or less.

3. The electrode active material according to claim 1, wherein the organic solvent is at least one of alcohols, glycols, esters, or amides.

4. A battery, comprising a mixture layer having an electrode active material according to claim 1.

5. An all-solid-state battery, comprising:
an all-solid-electrolyte layer; and
a mixture layer that is laminated on the all-solid-electrolyte layer and has the electrode active material according to claim 1.
